(19) United States
(12) Patent Application Publication
(10) Pub. No.: US 2023/0102543 A1
(43) Pub. Date: Mar. 30, 2023

(54) SYSTEM, METHOD, OR PROGRAM FOR EVALUATING CONTENT SPOKEN AT MEETING OR BRIEFING

(71) Applicant: KONICA MINOLTA, INC., Tokyo (JP)

(72) Inventor: Takashi OTSUKA, Kobe-shi (JP)

(73) Assignee: KONICA MINOLTA, INC., Tokyo (JP)

(21) Appl. No.: 17/898,518

(22) Filed: Aug. 30, 2022

(30) Foreign Application Priority Data
Sep. 28, 2021 (JP) 2021-158089

(51) Int. Cl. G10L 17/22; G10L 25/51

(52) U.S. Cl. CPC G10L 17/22; G10L 25/51

(57) ABSTRACT

A system that evaluates spoken content, includes: an acquirer that acquires each content spoken by a plurality of participants in a meeting or a briefing; an identifier for identifying each speaker of the each spoken content; and an evaluator for evaluating the each spoken content, wherein the identifier identifies whether the each spoken content is content spoken by a first speaker, or by a second speaker or apparatus that interprets content spoken by the first speaker, and the evaluator evaluates content spoken by an identified speaker that is the first speaker, or the second speaker or apparatus.

The entire disclosure of Japanese patent Application No. 2021-158089, filed on Sep. 28, 2021, is incorporated herein by reference in its entirety.

### BACKGROUND

### Technological Field

The present disclosure relates to a system for evaluating content spoken at a meeting or briefing, and more specifically, to a technique for evaluating content spoken by a participant at a meeting or briefing in which an interpreter participates.

### Description of the Related art

A system for evaluating content spoken by a participant at a meeting, a briefing, or the like is known. Such an evaluation system may acquire content spoken by each participant and analyze the spoken content, thereby providing feedback to each participant.

However, in a case of a meeting or the like with an interpreter, a conventional evaluation system evaluates both content spoken by a certain participant and content spoken by an interpreter who interprets the content spoken by the participant. Therefore, there is a problem that the same spoken content is evaluated twice, and feedback cannot be accurately provided to each participant.

With respect to a system for evaluating content spoken by a participant at a meeting or briefing, for example, JP 2017-215931 A discloses a conference support system “for supporting a conference receives an input of utterance details being the details of utterance from participants in the conference, determines the type of corresponding utterance on the basis of the utterance details input to the input part, and outputs at least either one of the utterance details, evaluation on the conference, or evaluation on the participants on the basis of a result of determination performed by the determination part” (refer to [Abstract]).

According to the technique disclosed in JP 2017-215931 A, in a case of a meeting or the like with an interpreter, both content spoken by a certain participant and content spoken by an interpreter who interprets the content spoken by the participant are evaluated. As a result, the same spoken content is evaluated twice, and feedback cannot be accurately provided to each participant. Therefore, there is a need for a technique for preventing the same spoken content from being evaluated twice in a meeting or the like with an interpreter.

### SUMMARY

The present disclosure has been made in view of the above background, and an object in one aspect is to provide a technique for preventing the same spoken content from being evaluated twice in a meeting or the like with an interpreter.

To achieve the abovementioned object, according to an aspect of the present invention, there is provided a system that evaluates spoken content, and the system reflecting one aspect of the present invention comprises: an acquirer that acquires each content spoken by a plurality of participants in a meeting or a briefing; an identifier for identifying each speaker of the each spoken content; and an evaluator for evaluating the each spoken content, wherein the identifier identifies whether the each spoken content is content spoken by a first speaker, or by a second speaker or apparatus that interprets content spoken by the first speaker, and the evaluator evaluates content spoken by an identified speaker that is the first speaker, or the second speaker or apparatus.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing an application example of an evaluation system according to an embodiment;

FIG. 2 is a diagram showing an example of a hardware configuration of an information processing apparatus used as the evaluation system;

FIG. 3 is a diagram showing an example of an evaluation screen for an entire meeting;

FIG. 4 is a diagram showing an example of an evaluation screen for a speaker (participant);

FIG. 5 is a flowchart showing a first example of a processing procedure of the evaluation system;

FIG. 6 is a diagram showing an example of a notification screen;

FIG. 7 is a flowchart showing a second example of a processing procedure of the evaluation system; and

FIG. 8 is a diagram showing an application example of the evaluation system.

### DETAILED DESCRIPTION OF EMBODIMENTS

Hereinafter, one or more embodiments of the technical idea of the present invention will be described with reference to the drawings. However, the scope of the invention is not limited to the disclosed embodiments. In the following description, the same components are denoted by the same reference signs. Their names and functions are also the same. Therefore, detailed descriptions thereof will not be repeated.

<A. System>

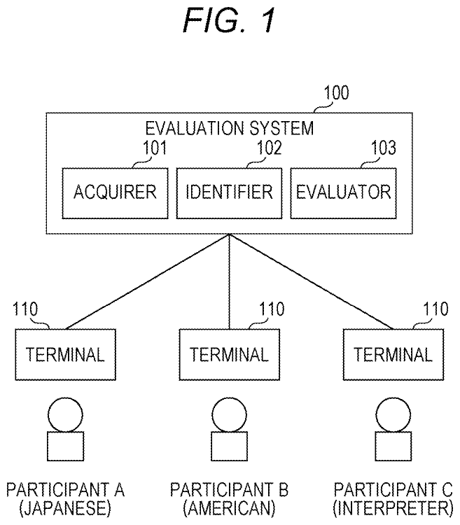

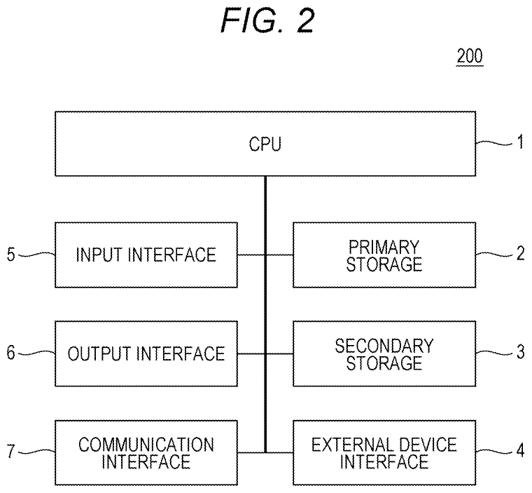

With reference to FIGS. 1 and 2, a configuration and operation overview of an evaluation system 100 according to the present embodiment will be described. The evaluation system 100 is for evaluating content spoken by a participant at a meeting or the like. In the following description, a “participant” means a person participating in a meeting or a briefing. The participant may include both a regular participant and an interpreter. For example, the participant may include a participant A (Japanese), a participant B (American), and a participant C (interpreter who interprets content spoken by the participant A from Japanese into English). The participant may include both a person who speaks at the meeting and a person who does not speak at the meeting. The “speaker” means a person who speaks at the meeting. For example, in a case where the participant A speaks at the meeting or the like, the participant A is a speaker. Furthermore, a participant who interprets content spoken by a certain speaker may be referred to as an “interpreter”. In one aspect, the “participant” and the “speaker” may not be a human For example, the participant C may be a computer, device, robot, or the like for translating content spoken by the participant A, and the participant B may be a remote-operated computer, apparatus, robot, or the like.

The “spoken content” is content spoken by each participant in the meeting. Furthermore, the spoken content may include content spoken by an interpreter. For example, there may be description that “A first speaker (participant A) delivers first speaking A second speaker (participant C) interprets content of the first speaking and delivers second speaking.”.

FIG. 1 is a diagram showing an application example of the evaluation system 100 according to the present embodiment. Functions and operation overview of the evaluation system 100 will be described with reference to FIG. 1. In the following description, as an example, it is assumed that the participant A (Japanese), the participant B (American), and the participant C (interpreter) participate in the meeting. The participant C interprets content of the first speaking (in Japanese) by the participant A and delivers the second speaking (in English). The participant A (Japanese) understands English but speaks in Japanese. Note that the meeting shown in FIG. 1 is merely an example, and the application example of the evaluation system 100 is not limited to the meeting shown in FIG. 1. In one aspect, the evaluation system 100 can further evaluate a meeting including an arbitrary number of any participants, such as a meeting including a participant D (an interpreter who interprets content spoken by the participant B from English into Japanese).

The evaluation system 100 may collect each spoken content at, for example, an online meeting, an online briefing, or the like, and analyze each spoken content. The evaluation system 100 may generate and output feedback to individual participants, evaluation of an entire meeting, or the like, on the basis of a result of analyzing each spoken content. The evaluation system 100 includes a function of identifying content spoken by a certain participant and content spoken by an interpreter who interprets the content spoken by the participant, and evaluating either the content spoken by the certain participant or the content spoken by the interpreter (two spoken contents of the same meaning). In one aspect, the evaluation system 100 may be implemented as a server, a cluster, or a cloud system.

The evaluation system 100 includes an acquirer 101, an identifier 102, and an evaluator 103. The evaluation system 100 is formed to be able to communicate with a terminal 110 of each participant via a network. In one aspect, the evaluation system 100 may be formed to be able to communicate with the terminal 110 of each participant via a local area network (LAN). In another aspect, the evaluation system 100 may be formed to be able to communicate with the terminal 110 of each participant via a wide area network such as the Internet. In another aspect, the evaluation system 100 may be connected to the terminal 110 of each participant via a wired network or a wireless network. In another aspect, the evaluation system 100 and the terminal 110 may transmit and receive data by using any communication protocol such as Transmission Control Protocol (TCP)/Internet Protocol (IP), User Datagram Protocol (UDP), or Hyper Text Transfer Protocol (http), or a combination of these communication protocols.

The acquirer 101 acquires content spoken by each of a plurality of participants. In one aspect, the acquirer 101 may acquire, from each of a plurality of terminals 110, audio data of each of the plurality of participants. In another aspect, the acquirer 101 may acquire, from each of a plurality of terminals 110, text data generated on the basis of the audio data of each of the plurality of participants. In another aspect, the acquirer 101 may include a function of converting content spoken by each of the plurality of participants into text data (text of spoken content).

The acquirer 101 outputs the content spoken by each of the plurality of participants to the identifier 102. In one aspect, the acquirer 101 may output the content spoken by each of the plurality of participants to the identifier as audio data. In another aspect, the acquirer 101 may output the content spoken by each of the plurality of participants to the identifier as text data.

The identifier 102 identifies which participant has spoken content input from the acquirer 101. As an example, the identifier 102 may automatically generate a name of a participant, such as the participant A, the participant B, or the participant C, and may identify which one of the participant A, the participant B, and the participant C has spoken each spoken content.

In one aspect, the identifier 102 may generate three names of the participant A, the participant B, and the participant C, in a case where it is determined, from waveforms of audio data of respective spoken contents, that three persons participate in the meeting. In this case, the identifier 102 may group spoken contents having similar waveforms of audio data, and may define respective spoken content groups as contents spoken by the participant A, the participant B, and the participant C.

In another aspect, to identify a participant, the identifier 102 may compare previously input audio data of each participant with audio data of content spoken during the meeting. In this case, the identifier 102 may identify, for example, spoken content having a waveform similar to a waveform of previously registered audio data of the participant A, as audio data of the participant A.

After identifying a speaker (participant) of each spoken content, the identifier 102 labels each spoken content with a speaker (participant). Alternatively, after identifying a speaker (participant) of each spoken content, the identifier 102 associates each spoken content with a speaker (participant) with an arbitrary means. The arbitrary means is, for example, a relational database, a Not only SQL (NoSQL) database, a comma-separated values (CSV) file, or the like.

Furthermore, the identifier 102 may also identify whether or not certain spoken content is an interpretation of another spoken content. For example, the identifier 102 compares content of the first speaking with content of the second speaking immediately after the first speaking (the second speaking delivered after the first speaking). As a result of the comparison, the identifier 102 may determine that content of the second speaking is an interpretation of content of the first speaking, on the basis that the first speaking and the second speaking are in different languages and are the same in content. Determination of sameness between content of the first speaking and content of the second speaking does not require exact match. It may be determined that the contents have a certain degree or more of similarity, on the basis of a model or the like generated by machine learning.

In one aspect, as a result of the comparison, the identifier 102 may determine that content of the second speaking is an interpretation of content of the first speaking, on the basis that the first speaking and the second speaking are in different languages. In another aspect, as a result of the comparison, the identifier 102 may determine that content of the second speaking is an interpretation of content of the first speaking, on the basis that content of the first speaking and content the second speaking are the same (have a certain degree or more of similarity).

In addition, as a result of the comparison, the identifier 102 may determine that content of the second speaking is mistranslation of content of the first speaking, on the basis that the content of the first speaking and content of the second speaking are in different languages, and that content of the second speaking is different from content of the first speaking. In this case, by comparing a waveform of the second speaking with a waveform of content previously spoken in the current meeting, or the like, the identifier 102 may identify which participant has delivered the second speaking (may determine whether or not content of the second speaking is content spoken by an interpreter).

On the basis of determination that content of the second speaking is an interpretation of content of the first speaking (mistranslation may also be included in the interpretation), the identifier 102 associates the second speaking and the first speaking to indicate that the content of the second speaking and content of the first speaking are the same. As an example, the identifier 102 may label the content of the second speaking as an interpretation of the content of the first speaking.

The evaluator 103 may generate evaluation of content spoken by each participant, evaluation of the entire meeting, and feedback to each participant. The evaluation may be, for example, evaluation based on psychological safety. An evaluation item of the psychological safety may include, as an example, a “critical remark”, a “constructive critical remark”, a “remark on own problem/anxiety/mistake”, a “speaking about new proposal/opinion”, a “question about unknown”, and the like. Evaluation of content spoken by each participant may include feedback of interpretation by an interpreter.

In the example shown in FIG. 1, the evaluator 103 includes either content spoken by the participant A (Japanese) or content spoken by the participant C (interpreter who interprets content spoken by the participant A from Japanese into English) as an evaluation target according to a type of evaluation to be generated.

When generating evaluation and feedback of the entire meeting, the evaluator 103 excludes the content spoken by the participant A (Japanese) as an evaluation target, and includes the content spoken by the participant C (interpreter who interprets content spoken by the participant A from Japanese into English) as an evaluation target. This is because content actually conveyed to the participant B (American) is content spoken by the participant C (interpreter), and the content spoken by the participant C directly affects psychological safety of the participant B.

When generating evaluation and feedback of content spoken by each participant, the evaluator 103 excludes the content spoken by the participant C (interpreter who interprets content spoken by the participant A from Japanese into English) as an evaluation target, and includes the content spoken by the participant A (Japanese) as an evaluation target. This is because the evaluation and feedback on the participant A should be based on the speaking directly delivered by the participant A.

As described above, the evaluation system 100 evaluates either the content spoken by the participant A or the content spoken by the participant C according to evaluation data to be generated, thereby preventing both the content spoken by the participant A and the content spoken by the participant C, which are the same in meaning, from being evaluated (prevent evaluation of the same spoken content twice).

The evaluator 103 may generate feedback for the participant A and the participant C on the basis of a degree of coincidence of the content spoken by the participant A (Japanese) and the content spoken by the participant C (interpreter who interprets content spoken by the participant A from Japanese into English), or the like. For example, the evaluator 103 may generate feedback including advice about a mistranslated spoken content, an easily interpretable expression, or the like to the participant A. The evaluator 103 may generate feedback on mistranslation or the like for the participant C. The degree of coincidence of the spoken contents here may include information regarding not only meaning of words but also information regarding whether or not nature of the spoken contents match. In one aspect, nature of spoken content may be represented by an evaluation item of psychological safety. For example, in a case where content spoken by the participant A (Japanese) is classified as a “constructive critical remark” and content spoken by the participant C (interpreter who interprets content spoken by the participant A from Japanese into English) is classified as a “critical remark”, the nature of the contents spoken by the both parties are different. The evaluator 103 may generate, for at least either the participant A or the participant C, feedback including information regarding discrepancy in nature of the spoken content.

In middle of the meeting, the evaluator 103 may notify at least either the participant A (Japanese) or the participant C (interpreter who interprets content spoken by the participant A from Japanese into English) of mistranslation at a time point when the discrepancy in nature of the content spoken by the participant A and the nature of the content spoken by the participant C is detected.

The terminal 110 provides a video meeting (video call) function for the participants, and transmits content spoken by a participant (audio data or text) to the evaluation system 100. The terminal 110 may receive various notifications (such as mistranslation notification), evaluation (such as evaluation of the entire meeting and evaluation of content spoken by each participant), feedback, and the like from the evaluation system 100. In one aspect, the terminal 110 may be any information terminal such as a personal computer, a smartphone, a tablet, or a wearable device.

In one aspect, by using a browser function, the terminal 110 may be in conjunction with the evaluation system 100 via a web application delivered from the evaluation system 100. In this case, the terminal 110 may acquire content spoken by a participant via a browser, transmit the spoken content to the evaluation system 100, and receive various notifications, various kinds of evaluations, and the like from the evaluation system 100. The evaluation system 100 delivers a web application including HyperText Markup Language (HTML), Cascading Style Sheets (CSS), Java (registered trademark) script, or the like to the terminal 110.

In another aspect, the terminal 110 may be in conjunction with the evaluation system 100 via an application installed on the terminal 110. In this case, the terminal 110 may acquire content spoken by a participant via the application, transmit the spoken content to the evaluation system 100, and receive various notifications, various kinds of evaluations, and the like from the evaluation system 100.

Further, in one aspect, the application for the terminal 110 to be in conjunction with the evaluation system 100 may be integrated with a video meeting (video call) application, may be an add-in of the video meeting (video call) application, or may be an independent application.

FIG. 2 is a diagram showing an example of a hardware configuration of an information processing apparatus 200 used as the evaluation system 100. In one aspect, the evaluation system 100 may implement each function of the evaluation system 100 shown in FIG. 1 by executing a program on hardware shown in FIG. 2. In another aspect, the evaluation system 100 may be implemented on a cluster including one or more information processing apparatuses 200, or on a cloud system. In another aspect, the information processing apparatus 200 may be used as the terminal 110.

The information processing apparatus 200 includes a central processing unit (CPU) 1, a primary storage 2, a secondary storage 3, an external device interface 4, an input interface 5, an output interface 6, and a communication interface 7.

The CPU 1 may execute a program for implementing various functions of the evaluation system 100. The CPU 1 includes, for example, at least one integrated circuit. The integrated circuit may include, for example, at least one CPU, at least one field-programmable gate array (FPGA), a combination thereof, or the like.

The primary storage 2 stores a program executed by the CPU 1 and data referred to by the CPU 1. In one aspect, the primary storage 2 may be implemented by a dynamic random access memory (DRAM), a static random access memory (SRAM), or the like.

The secondary storage 3 is a nonvolatile memory, and may store a program executed by the CPU 1 and data referred to by the CPU 1. In this case, the CPU 1 executes the program read from the secondary storage 3 into the primary storage 2, and refers to data read from the secondary storage 3 into the primary storage 2. In one aspect, the secondary storage 3 may be implemented by a hard disk drive (HDD), a solid-state drive (SSD), an erasable programmable read-only memory (EPROM), an electrically erasable programmable read-only memory (EEPROM), a flash memory, or the like.

The external device interface 4 may be connected to any external device such as a printer, a scanner, or an external HDD. In one aspect, the external device interface 4 may be implemented by a universal serial bus (USB) terminal or the like.

The input interface 5 may be connected to any input apparatus such as a keyboard, a mouse, a touchpad, or a gamepad. In one aspect, the input interface 5 may be implemented by a USB terminal, a PS/2 terminal, a Bluetooth (registered trademark) module, or the like.

The output interface 6 may be connected to any output apparatus such as a cathode-ray tube display, a liquid-crystal display, or an organic electro-luminescence (EL) display. In one aspect, the output interface 6 may be implemented by a USB terminal, a D-sub terminal, a digital visual interface (DVI) terminal, a High-Definition Multimedia Interface (HDMI) (registered trademark) terminal, or the like.

The communication interface 7 is connected to a wired or wireless network device. In one aspect, the communication interface 7 may be implemented by a wired LAN port, a Wireless Fidelity (Wi-Fi (registered trademark)) module, or the like. In another aspect, the communication interface 7 may transmit and receive data by using a communication protocol such as TCP/IP or UDP.

<B. Evaluation of Spoken Content>

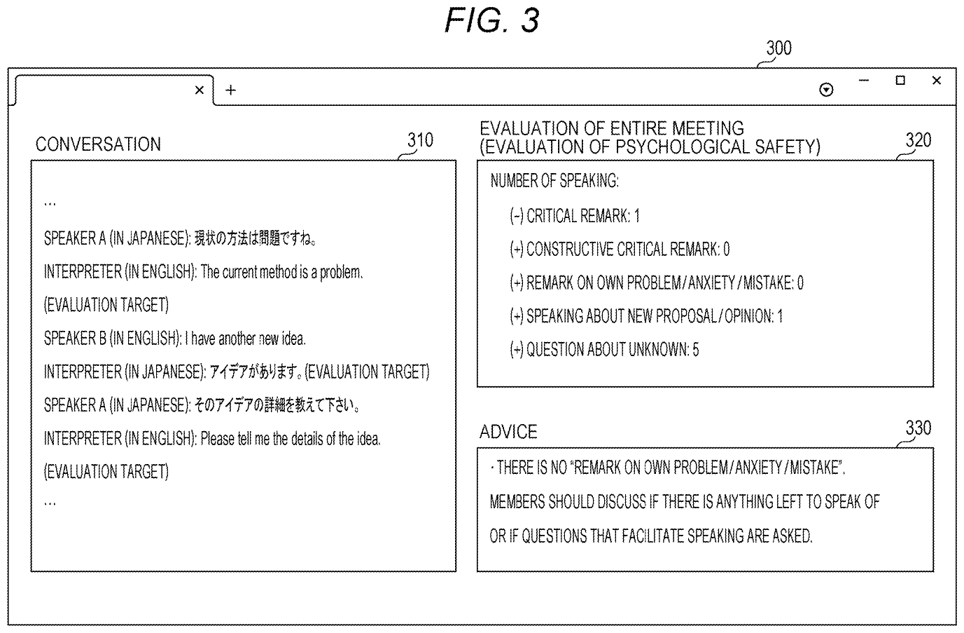

Next, evaluation of the entire meeting and evaluation of each speaker by the evaluation system 100 will be described with reference to FIGS. 3 to 5.

FIG. 3 is a diagram showing an example of an evaluation screen 300 for an entire meeting. The evaluation screen 300 for an entire meeting includes information and advice regarding evaluation of psychological safety of the entire meeting. The evaluation screen 300 for an entire meeting includes a conversation log 310, evaluation 320 of the entire meeting, and advice 330.

The conversation log 310 is a history of speaking by each participant during the meeting. In the example shown in FIG. 3, the conversation log 310 includes content spoken by the speaker A (participant A), content spoken by the speaker B (participant B), and content spoken by the interpreter (participant C). After the meeting, each participant can recall content of the meeting by viewing the conversation log 310. In one aspect, the conversation log 310 may include display of a label that allows discrimination of whether or not each spoken content is an evaluation target (for example, (evaluation target) shown in FIG. 3, or the like). In another aspect, the spoken content to be evaluated and other spoken content may be visually distinguished by an arbitrary means, such as being displayed in different colors, and displayed in the conversation log 310.

The evaluation system 100 includes content spoken by the speaker B (participant B) and content spoken by the interpreter (participant C) as evaluation targets, and does not include content spoken by the speaker A (participant A) as an evaluation target. This is because content actually conveyed to the participant B (American) is not content spoken by the participant A (Japanese) but is content spoken by the participant C (interpreter), and the content spoken by the participant C directly affects psychological safety of the participant B.

The evaluation 320 of the entire meeting includes psychological safety evaluation of the entire meeting. The evaluation system 100 classifies content spoken by each participant (evaluation targets only), counts the number of speaking for each category, and displays the counts. The classification may include, for example, a “critical remark”, a “constructive critical remark”, a “remark on own problem/anxiety/mistake”, a “speaking about new proposal/opinion”, a “question about unknown”, and the like. Evaluation score for each speaking is set for each classification (on a score, positive-negative scale, or the like, and evaluation score may or may not be even for each classification). In one aspect, the evaluation system 100 may output a comprehensive evaluation score of the entire meeting on the basis of the evaluation point for each classification and the number of speaking for each category.

The advice 330 includes advice or feedback for all participants of the meeting or briefing. The evaluation system 100 displays advice for further enhancing psychological safety in the meeting on the basis of unevenness in the number of speaking in each classification or the like. In the example shown in FIG. 3, because there is no “remark on own problem/anxiety/mistake”, the advice 330 includes approach to facilitate each participant to make a “remark on own problem/anxiety/mistake”.

After the meeting, the evaluation system 100 may transmit the evaluation screen 300 for an entire meeting or information to be displayed on the evaluation screen 300 for the entire meeting to the terminal 110 of each participant. In one aspect, the terminal 110 may receive, from the evaluation system 100, the evaluation screen 300 for the entire meeting by using the browser function, and display, on the display, the evaluation screen 300 for the entire meeting. In another aspect, the terminal 110 may receive, from the evaluation system 100, information to be displayed on the evaluation screen 300 for the entire meeting via an application installed on the terminal 110, and display, on the display, the evaluation screen 300 for the entire meeting. In another aspect, the evaluation system 100 may deliver an evaluation result, instead of the evaluation screen 300 for the entire meeting, to each terminal 110 by e-mail or the like. The evaluation result is in an arbitrary format and includes various kinds of evaluation information.

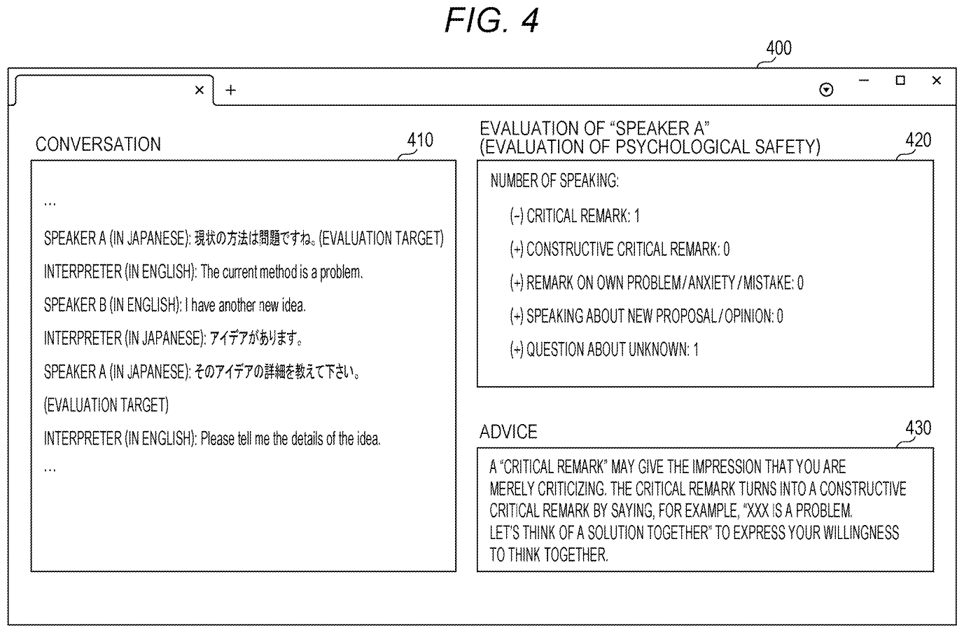

FIG. 4 is a diagram showing an example of an evaluation screen 400 for a speaker (participant). The evaluation screen 400 for a speaker (participant) includes information and advice regarding evaluation of psychological safety about content spoken by each participant (speaker). The example in FIG. 4 is evaluation of content spoken by the speaker A (participant A). The evaluation system 100 generates an evaluation screen 400 for a speaker (participant) for each participant, and transmits the evaluation screen 400 for the speaker (participant) to the terminal 110 of each participant. The evaluation screen 400 for a speaker (participant) includes a conversation log 410, evaluation 420 of the speaker, and advice 430.

The conversation log 410 is a history of speaking by each participant during the meeting. In the example shown in FIG. 4, the conversation log 410 includes content spoken by the speaker A (participant A), content spoken by the speaker B (participant B), and content spoken by the interpreter (participant C). In one aspect, the conversation log 410 may include display of a label that allows discrimination of whether or not each spoken content is an evaluation target (for example, (evaluation target) shown in FIG. 4, or the like). In another aspect, the spoken content to be evaluated and other spoken content may be visually distinguished by an arbitrary means, such as being displayed in different colors, and displayed in the conversation log 410.

Unlike a case of evaluation of an entire meeting, the evaluation system 100 includes content spoken by the speaker A (participant A) as an evaluation target, and does not include content spoken by the speaker B (participant B) and content spoken by the interpreter (participant C) as evaluation targets. This is because the evaluation and feedback on the participant A should be based on the speaking directly delivered by the participant A.

The evaluation 420 of the speaker includes psychological safety evaluation of content spoken by the speaker. The evaluation system 100 classifies content spoken by the speaker to be evaluated (in the example in FIG. 4, the participant A), counts the number of speaking for each category, and displays the counts. In one aspect, the evaluation system 100 may output a comprehensive evaluation score of the entire meeting on the basis of the evaluation point for each classification and the number of speaking for each category.

The advice 430 includes advice or feedback directed to the participant to be evaluated (in the example in FIG. 4, the participant A). The evaluation system 100 displays advice for further enhancing psychological safety in the meeting on the basis of unevenness in the number of speaking in each classification or the like. In the example shown in FIG. 4, the speaker A (participant A) makes a “critical remark”, and the advice 430 includes advice for the speaker A (participant A) to make a critical remark in a more constructive manner.

After the meeting, the evaluation system 100 may generate, for each speaker (participant), the evaluation screen 400 for an individual speaker (participant) or information to be displayed on the evaluation screen 400 for a speaker (participant), and transmits the generated information to the terminal 110 of each participant. In one aspect, the terminal 110 may receive, from the evaluation system 100, the evaluation screen 400 for a speaker (participant) by using the browser function, and display, on the display, the evaluation screen 400 for a speaker (participant). In another aspect, the terminal 110 may receive, from the evaluation system 100, information to be displayed on the evaluation screen 400 for a speaker (participant) via an application installed on the terminal 110, and display, on the display, the evaluation screen 400 for a speaker (participant). In another aspect, the evaluation system 100 may deliver an evaluation result, instead of the evaluation screen 400 for a speaker (participant), to each terminal 110 by e-mail or the like. The evaluation result is in an arbitrary format and includes various kinds of evaluation information.

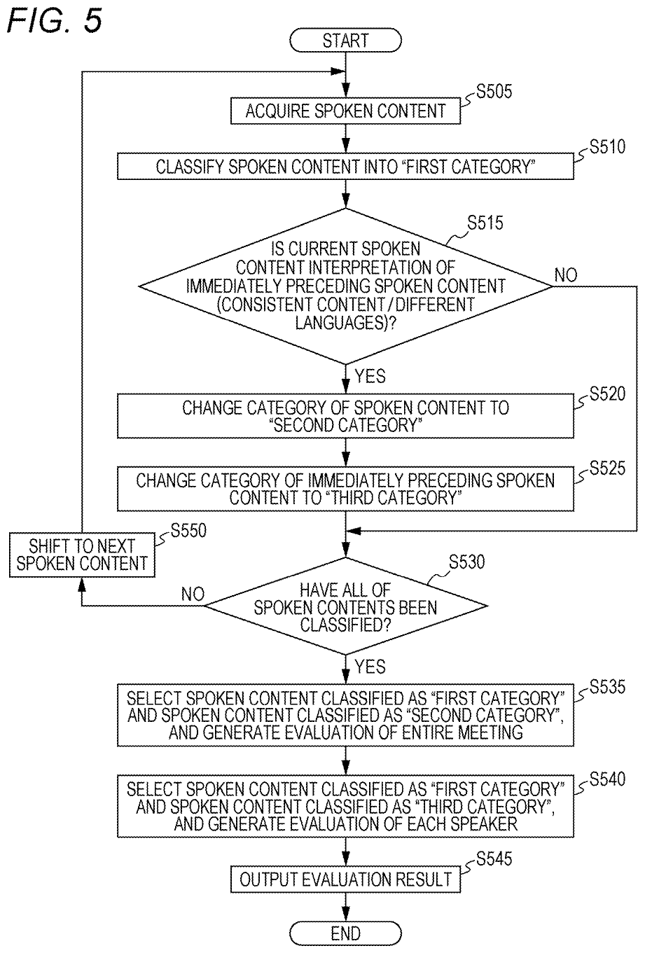

FIG. 5 is a flowchart showing a first example of a processing procedure of the evaluation system 100. In one aspect, the CPU 1 may read a program for performing the processing in FIG. 5 from the secondary storage 3 into the primary storage 2 and execute the program. In another aspect, part or all of the processing may be implemented as a combination of circuit elements formed to execute the processing.

In step S505, the evaluation system 100 acquires content spoken by a speaker (participant). More specifically, the acquirer 101 receives spoken content (audio data or text generated from audio data) from each terminal 110 via the network.

In step S510, the evaluation system 100 classifies the received spoken content into a “first category”. Classification of spoken content includes the “first category”, a “second category”, and a “third category”. The “first category” means uninterpreted content spoken by a participant. The “second category” means content spoken by an interpreter. The “third category” means interpreted content spoken by a participant. For example, it is assumed that the participant A (Japanese) delivers speaking A, the participant C (interpreter) delivers speaking C by interpreting the speaking A, and the participant B (American) delivers speaking B as a response to the speaking A. In this case, because content of the speaking A is interpreted content spoken by a participant, the speaking A is classified as the “third category”. Because content of the speaking B is uninterpreted content spoken by a participant, the speaking B is classified as the “first category”. Because content of the speaking C is content spoken by an interpreter, the speaking C is classified as the “second category”. The evaluation system 100 cannot discriminate which category the speaking acquired in step S510 belongs to, and thus tentatively classifies the received spoken content into the “first category”.

In step S515, the evaluation system 100 determines whether or not current spoken content is an interpretation of immediately preceding spoken content. In one aspect, the evaluation system 100 may determine whether or not the current spoken content is an interpretation of the immediately preceding spoken content on the basis of whether or not the current spoken content and the immediately preceding spoken content are consistent, on the basis of whether or not the current spoken content and the immediately preceding spoken content are in different languages, or on the basis of both thereof. In a case where it is determined that the current spoken content is an interpretation of the immediately preceding spoken content (YES in step S515), the evaluation system 100 shifts the control to step S520. Otherwise (NO in step S520), the evaluation system 100 shifts the control to step S530.

In step S520, the evaluation system 100 changes the category of the current spoken content to “second category” (content spoken by an interpreter).

In step S525, the evaluation system 100 changes the category of the immediately preceding spoken content to the “third category” (interpreted content spoken by a participant).

In step S530, the evaluation system 100 determines whether or not all of the spoken contents have been classified. In a case where it is determined that all of the spoken contents have been classified (YES in step S530), the evaluation system 100 shifts the control to step S535. Otherwise (NO in step S530), the evaluation system 100 shifts the control to step S535.

In step S535, the evaluation system 100 selects spoken content classified as the “first category” and spoken content classified as the “second category”, and generates evaluation of the entire meeting. In the example of the meeting shown in FIG. 1, the evaluation system 100 generates evaluation of the entire meeting on the basis of the content spoken by the participant B (American) in the “first category” (uninterpreted content spoken by a participant), and the content spoken by the participant C (interpreter) in the “second category” (content spoken by an interpreter). More specifically, on the basis of the spoken content classified as the “first category” and the spoken content classified as the “second category”, the evaluation system 100 may generate various types of information included in the evaluation screen 300 for an entire meeting.

In step S540, the evaluation system 100 selects spoken content classified as the “first category” and spoken content classified as the “third category”, and generates evaluation of each speaker (each participant). In the example of the meeting shown in FIG. 1, the evaluation system 100 generates evaluation of the participant B (American) on the basis of the content spoken by the participant B in the “first category” (uninterpreted content spoken by a participant). In addition, the evaluation system 100 generates evaluation of the participant A (Japanese) on the basis of the content spoken by the participant A in the “third category” (interpreted content spoken by a participant). More specifically, on the basis of the spoken content classified as the “first category” and the spoken content classified as the “third category”, the evaluation system 100 may generate various types of information included in the evaluation screen 400 for a speaker (participant).

In step S545, the evaluation system 100 outputs an evaluation result. More specifically, the evaluation system 100 may transmit the evaluation screen 300 for the entire meeting to some or all of the terminals 110, and may transmit the evaluation screen 400 for a speaker (participant) to the terminal 110 of each participant, for example.

In step S550, the evaluation system 100 shifts a classification target to a next spoken content.

<C. Evaluation of Spoken Content (Modifications)>

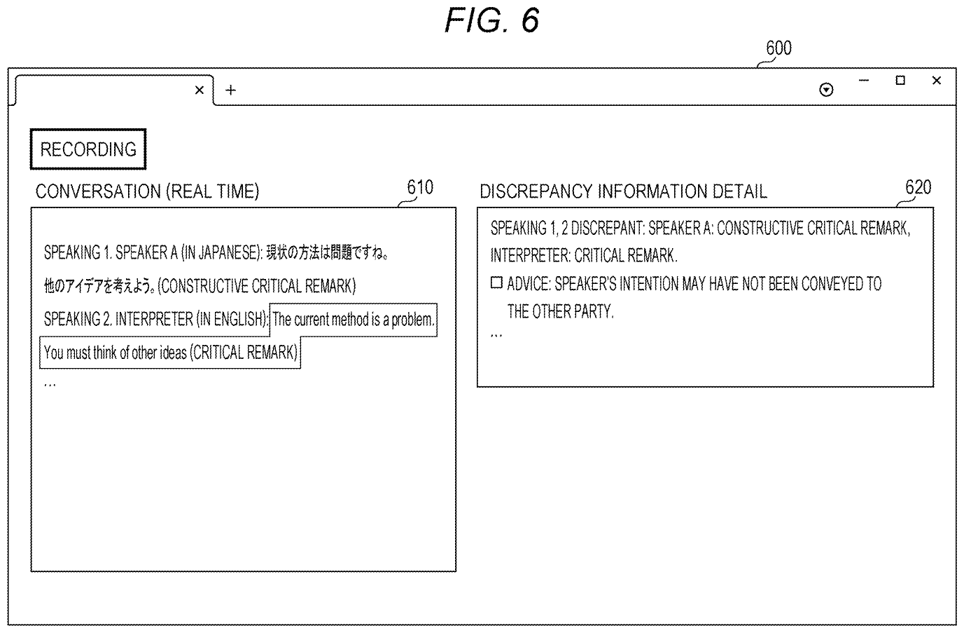

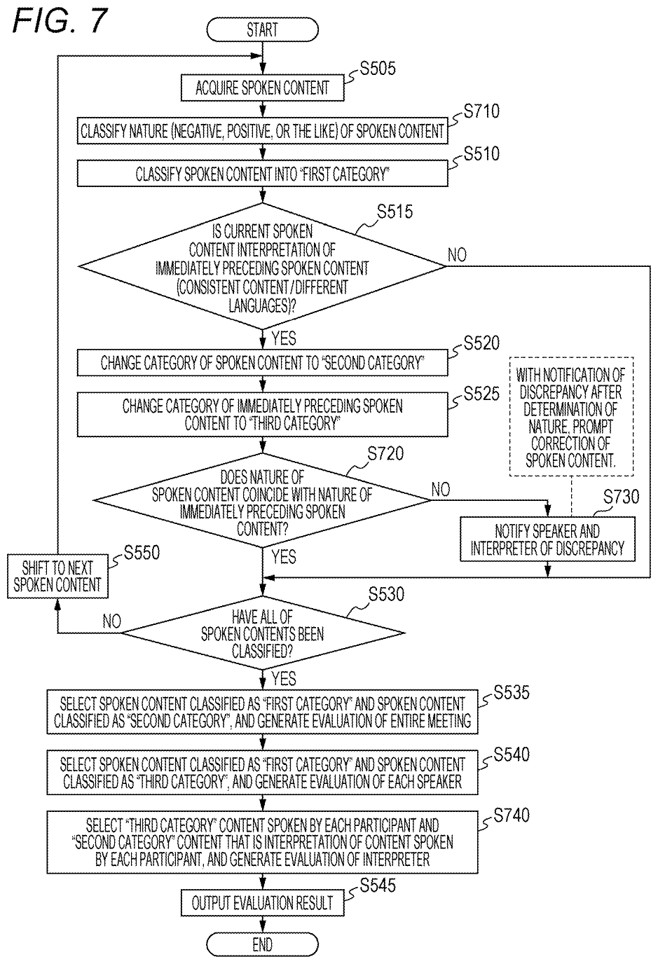

Next, modifications of the evaluation of spoken content will be described with reference to FIGS. 6 and 7. The examples shown in FIGS. 6 and 7 relate to notification and evaluation in a case where there is discrepancy between certain spoken content and an interpretation of the spoken content.

FIG. 6 is a diagram showing an example of a notification screen 600. The notification screen 600 may be delivered to the terminals 110 of some or all participants during the meeting. The notification screen 600 includes a conversation log 610 and a discrepancy information detail 620.

The conversation log 610 is a history of speaking by each participant during the meeting. Display of the conversation log 610 is updated in real time when a participant speaks during the meeting. In the example of the meeting shown in FIG. 1, the participant A (Japanese) may check, by viewing the conversation log 610 in real time, how the content spoken by the participant A has been interpreted.

The discrepancy information detail 620 includes information regarding discrepancy in content or nature (positive or negative) between certain spoken content and an interpretation of the certain spoken content. The discrepancy in nature means that, for example, certain spoken content is a constructive (positive) remark, while an interpretation of the certain spoken content is a critical (negative) remark, vice versa, or the like. In one aspect, the discrepancy information detail 620 may further include advice on a next action or the like.

In the example shown in FIG. 6, the discrepancy information detail 620 includes details of information regarding discrepancy in nature between the content spoken by the speaker A (participant A) and content spoken by the interpreter (participant C) (an interpretation of the content spoken by the speaker A (participant A)), and advice on a next action or the like.

In one aspect, the evaluation system 100 may transmit the notification screen 600 to either one or both of the terminal 110 of the speaker A (participant A) and the terminal 110 of the interpreter (participant C). The speaker A (participant A) or the interpreter (participant C) can correct the spoken content by checking the notification screen 600.

In another aspect, the evaluation system 100 may generate advice (easy-to-understand expression or the like) for the speaker A (participant A) on the basis of information included in the notification screen 600, and transmit the advice to the terminal of the speaker A (participant A). In another aspect, the evaluation system 100 may generate advice for the interpreter (participant C) on the basis of information included in the notification screen 600, and transmit the advice to the terminal of the interpreter (participant C).

FIG. 7 is a flowchart showing a second example of a processing procedure of the evaluation system 100. The flowchart shown in FIG. 7 is different from the flowchart shown in FIG. 5 in generating notification and evaluation based on information regarding discrepancy in content between certain spoken content and an interpretation of the certain spoken content.

In one aspect, the CPU 1 may read a program for performing the processing in FIG. 7 from the secondary storage 3 into the primary storage 2 and execute the program. In another aspect, part or all of the processing may be implemented as a combination of circuit elements formed to execute the processing. Among the processing shown in FIG. 7, processing the same as the processing in FIG. 5 is denoted by the same step number. Therefore, description of the same processing will not be repeated.

In step S710, the evaluation system 100 classifies nature (negative, positive, or the like) of spoken content. Separately from the classification of spoken content (the first category, second category, or third category), the evaluation system 100 classifies nature of the spoken content.

In step S720, the evaluation system 100 determines whether or not nature of current spoken content coincides with nature of immediately preceding spoken content. In a case where it is determined that the nature of the current spoken content coincides with the nature of the immediately preceding spoken content (YES in step S720), the evaluation system 100 shifts the control to step S530. Otherwise (NO in step S720), the evaluation system 100 shifts the control to step S730. In one aspect, the evaluation system 100 may determine whether or not meaning of current spoken content coincides with meaning of immediately preceding spoken content. In this case, the evaluation system 100 may compare both the spoken contents and extract spoken contents having discrepancy in meaning, and may generate information regarding the discrepancy in meaning on the basis of a result of the extraction. The evaluation system 100 may notify of the information regarding the discrepancy in meaning in step S730 or step S740. As an example, the information regarding discrepancy in meaning may include advice about easy-to-understand expression or misleading expression in interpretation. In another aspect, the evaluation system 100 may determine both whether or not nature of current spoken content coincides with nature of immediately preceding spoken content, and whether or not meaning of the current spoken content coincides with meaning of the immediately preceding spoken content.

In step S730, the evaluation system 100 notifies the speaker and the interpreter (or either one) of the discrepancy in nature of the spoken content. The notification may include information regarding discrepancy in nature of the spoken content. The message may include, for example, advice about wording for matching nature of the spoken content, or the like. The evaluation system 100 transmits the notification screen 600 to the terminals 110 of the speaker and the interpreter (or either one). In one aspect, nature of spoken content may be represented not only by the meaning of words included in the spoken content, but also by an evaluation item of psychological safety. For example, in a case where content spoken by the participant A (Japanese) is classified as a “constructive critical remark” and content spoken by the participant C (interpreter who interprets content spoken by the participant A from Japanese into English) is classified as a “critical remark”, the nature of the contents spoken by the both parties are different.

In step S740, the evaluation system 100 selects “third category” content spoken by each participant and “second category” content that is an interpretation of content spoken by each participant, and generates evaluation of the interpreter. The evaluation may include, as an example, advice about easy-to-understand expression, misleading expression, or the like. Furthermore, the evaluation may include any advice for resolving discrepancy in nature of the spoken content.

<D. Application Example (Evaluation of Spoken Content in Meeting Room)>

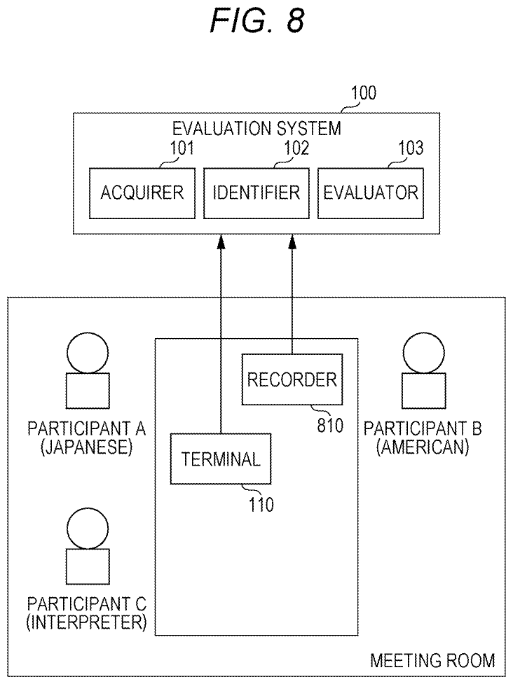

FIG. 8 is a diagram showing an application example of the evaluation system 100. With reference to FIG. 8, evaluation of a meeting held in a meeting room and evaluation of recorded data of a meeting held in past will be described. In the example shown in FIG. 8, the participant A (Japanese), the participant B (American), and the participant C (interpreter) are having a meeting or briefing in a meeting room.

The evaluation system 100 may acquire, from the terminal 110 installed in the meeting room, content spoken by each participant in the meeting room, and generate evaluation of the entire meeting and evaluation of content spoken by each participant. In one aspect, in a meeting held across a plurality of meeting rooms with a video call, the evaluation system 100 may acquire, from the terminal 110 installed in each meeting room, content spoken by each participant in each meeting room, and generate evaluation of the entire meeting and evaluation of content spoken by each participant. In another aspect, even in a case where some participants participate in a meeting at home and other participants participate in the meeting in a meeting room, the evaluation system 100 may generate evaluation of the entire meeting and evaluation of content spoken by each participant by combining the processing described with reference to FIGS. 1 and 8.

Furthermore, by acquiring recorded data recorded by a recorder 810 or the like, the evaluation system 100 may analyze the recorded data, and generate evaluation of the past entire meeting and evaluation of content spoken by each participant in the past. In one aspect, the evaluation system 100 may receive the recorded data from a terminal 110 via a network. In another aspect, the evaluation system 100 may provide a web page from which evaluation data of a past meeting can be downloaded. In another aspect, the terminal 110 may download evaluation data of any past meeting via an application installed on the terminal 110.

As described above, even in a meeting including an interpreter, the evaluation system 100 according to the present embodiment evaluates either certain spoken content or an interpretation of the certain spoken content, thereby preventing both the two spoken contents, which are the same in meaning, from being evaluated (prevent evaluation of the same spoken content twice).

Furthermore, by evaluating either certain spoken content or an interpretation of the certain spoken content according to evaluation data to be generated, the evaluation system 100 may generate both evaluation of the entire meeting and evaluation of content spoken by each participant.

Although embodiments of the present invention have been described and illustrated in detail, the disclosed embodiments are made for purposes of illustration and example only and not limitation. The scope of the present invention should be interpreted by terms of the appended claims, and intended to include meanings equivalent to the scope of the claims and all modifications within the scope. The disclosed contents described in the embodiment and modifications are intended to be implemented each alone or in combination wherever possible.

What is claimed is:

1. A system that evaluates spoken content, the system comprising:
an acquirer that acquires each content spoken by a plurality of participants in a meeting or a briefing;
an identifier for identifying each speaker of the each spoken content; and
an evaluator for evaluating the each spoken content,
wherein the identifier identifies whether the each spoken content is content spoken by a first speaker, or by a second speaker or apparatus that interprets content spoken by the first speaker, and
the evaluator evaluates content spoken by an identified speaker that is the first speaker, or the second speaker or apparatus.

2. The system according to claim 1,
wherein the identification of whether the each spoken content is content spoken by the first speaker, or by the second speaker or apparatus includes determination of whether or not the each spoken content is the same as immediately preceding spoken content.

3. The system according to claim 1,
wherein the identification of whether the each spoken content is content spoken by the first speaker, or by the second speaker or apparatus includes determination of whether or not the each spoken content and immediately preceding spoken content of the each spoken content are in different languages.

4. The system according to claim 1,
wherein the evaluation of spoken content includes exclusion of content spoken by the second speaker or apparatus as an evaluation target, and evaluation of content spoken by the first speaker.

5. The system according to claim 1,
wherein the evaluation of spoken content includes exclusion of content spoken by the first speaker as an evaluation target and inclusion of content spoken the second speaker or apparatus as an evaluation target.

6. The system according to claim 1,
wherein the evaluation of spoken content includes, in evaluation of an entire meeting, exclusion of content spoken by the first speaker as an evaluation target and inclusion of content spoken by the second speaker or apparatus as an evaluation target, and, in evaluation of content spoken by the first speaker, exclusion of content spoken by the second speaker or apparatus as an evaluation target and evaluation of content spoken by the first speaker.

7. The system according to claim 1,
wherein the evaluator compares content spoken by the first speaker with content spoken by the second speaker or apparatus immediately after the content spoken by the first speaker and extracts spoken contents having discrepancy in meaning, and
generates information regarding the discrepancy in meaning on the basis of a result of the extraction.

8. The system according to claim 1,
wherein the evaluator, on the basis of comparing content spoken by the first speaker with content spoken by the second speaker or apparatus immediately after the content spoken by the first speaker and extracting spoken contents having discrepancy in nature, notifies at least either the first speaker, or the second speaker or apparatus of information regarding discrepancy in nature of the spoken content.

9. The system according to claim 1,
wherein the evaluator evaluates content spoken by each of the plurality of participants and generates a result of evaluation of an entire meeting, and
the result of evaluation of the entire meeting does not include evaluation of content spoken by the first speaker.

10. The system according to claim 1,
wherein the evaluator evaluates content spoken by each of the plurality of participants and generates a result of evaluation of each of the plurality of participants, and
the result of evaluation of each of the plurality of participants does not include evaluation of content spoken by the second speaker or apparatus.

11. The system according to claim 1,
wherein the evaluator outputs the generated evaluation result.

12. A method for evaluating spoken content, the method comprising:
acquiring each content spoken by a plurality of participants in a meeting or a briefing;
identifying whether the each spoken content is content spoken by a first speaker, or by a second speaker or apparatus that interprets content spoken by the first speaker; and
evaluating content spoken by an identified speaker that is the first speaker, or the second speaker or apparatus.

13. The method according to claim 12,
wherein identifying whether the each spoken content is content spoken by the first speaker, or by the second speaker or apparatus includes determining whether or not the each spoken content is the same as immediately preceding spoken content.

14. The method according to claim 12,
wherein identifying whether the each spoken content is content spoken by the first speaker, or by the second speaker or apparatus includes determining whether or not the each spoken content and immediately preceding spoken content of the each spoken content are in different languages

15. The method according to claim 12,
wherein the evaluating spoken content includes excluding content spoken by the second speaker or apparatus as an evaluation target, and evaluation of content spoken by the first speaker.

16. The method according to claim 12,
wherein the evaluating spoken content includes excluding content spoken by the first speaker as an evaluation target and including content spoken by the second speaker or apparatus as an evaluation target.

17. The method according to claim 12,
wherein the evaluating spoken content includes, in evaluation of an entire meeting, excluding content spoken by the first speaker as an evaluation target and including content spoken by the second speaker or apparatus as an evaluation target, and, in evaluation of content spoken by the first speaker, excluding content spoken by the second speaker or apparatus as an evaluation target and evaluating content spoken by the first speaker.

18. The method according to claim 12, the method further comprising:
comparing content spoken by the first speaker with content spoken by the second speaker or apparatus immediately after the content spoken by the first speaker and extracting spoken contents having discrepancy in meaning, and
generating information regarding the discrepancy in meaning on the basis of a result of the extraction.

19. The method according to claim 12, the method further comprising:
on the basis of comparing content spoken by the first speaker with content spoken by the second speaker or apparatus immediately after the content spoken by the first speaker and extracting spoken contents having discrepancy in nature, notifying at least either the first speaker, or the second speaker or apparatus of information regarding discrepancy in nature of the spoken content.

20. The method according to claim 12,
wherein the evaluating spoken content includes evaluating content spoken by each of the plurality of participants and generating a result of evaluation of an entire meeting, and
the result of evaluation of the entire meeting does not include evaluation of content spoken by the first speaker.

21. The method according to claim 12,
wherein the evaluating spoken content includes evaluating content spoken by each of the plurality of participants and generating a result of evaluation of each of the plurality of participants, and
the result of evaluation of each of the plurality of participants does not include evaluation of content spoken by the second speaker or apparatus.

22. The method according to claim 12, the method further comprising outputting generated evaluation result.

23. A non-transitory recording medium storing a computer readable program causing a computer to execute the method according to claim 12.
